(19) United States
(12) Patent Application Publication
(10) Pub. No.: US 2024/0340924 A1
(43) Pub. Date: Oct. 10, 2024

(54) SIDELINK RESOURCE POOL CONFIGURATION FOR FR2 BEAM MANAGEMENT

(71) Applicant: Apple Inc., Cupertino, CA (US)

(72) Inventors: Huaning Niu, San Jose, CA (US); Chunxuan Ye, San Diego, CA (US); Wei Zeng, Saratoga, CA (US); Dawei Zhang, Saratoga, CA (US); Hong He, San Jose, CA (US); Haitong Sun, Cupertino, CA (US)

(21) Appl. No.: 18/624,259

(22) Filed: Apr. 2, 2024

Related U.S. Application Data
(60) Provisional application No. 63/494,026, filed on Apr. 4, 2023.

(51) Int. Cl. H04W 72/25; H04B 7/06; H04W 72/044; H04W 72/40

(52) U.S. Cl. CPC H04W 72/25; H04B 7/06954; H04W 72/046; H04W 72/40

(57) ABSTRACT

Techniques described herein include solutions for beam management in sidelink (SL) communications. In some aspects, user equipments (UEs) operating in SL are configured with a SL beam management resource pool by a base station. The SL beam management resource pool may be used to send a beam management message, such as a beam acquisition message, a beam failure recovery message, a beam maintenance message, etc. In some aspects, a resource in the SL beam management resource pool used to transmit the beam management message is selected based on an optimal beam determined by the UE. Resource pool configurations are provided for beamed transmission and beamed receiving, beamed transmission and quasi-omni receiving, and Rx beam training.

### REFERENCE TO RELATED APPLICATIONS

This Application claims the benefit of U.S. Provisional Application No. 63/494,026, filed on Apr. 4, 2023, the contents of which are hereby incorporated by reference in their entirety

### FIELD

This disclosure relates to wireless communication networks including techniques for configuring resource pools within wireless networks.

### BACKGROUND

Wireless communication networks may include user equipments (UEs), base stations, and/or other types of wireless devices capable of communicating with one another. During operation, the UEs may communicate with each other via sidelink (SL) signaling.

### BRIEF DESCRIPTION OF THE DRAWINGS

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

FIG. 1 is a schematic diagram illustrating a beam acquisition procedure between a base station and a user equipment (UE) in accordance with some aspects of the present disclosure.

FIG. 2 is a block diagram illustrating two UEs communicating using sidelink (SL) signaling in accordance with some aspects of the present disclosure.

FIG. 3 is a block diagram illustrating a wireless network including UEs configured to utilize a SL beam management resource pool in accordance with some aspects of the present disclosure.

FIG. 4 is a schematic diagram illustrating signaling between a base station and two UEs to perform a beam acquisition procedure in accordance with some aspects of the present disclosure.

FIG. 5 is a schematic diagram illustrating a beam acquisition procedure between two UEs in accordance with some aspects of the present disclosure.

FIGS. 6-8 are schematic diagrams illustrating SL beam management resource pool configurations for beamed transmission and beamed receiving in accordance with some aspects of the present disclosure.

FIGS. 9-10 are schematic diagrams illustrating SL beam management resource pool configurations for beamed transmission and quasi-omni receiving in accordance with some aspects of the present disclosure.

FIG. 11 is a schematic diagram illustrating signaling between a base station and two UEs to perform a beam management procedure in accordance with some aspects of the present disclosure.

FIG. 12 is a schematic diagram illustrating a SL beam management resource pool configuration for an Rx beam training procedure in accordance with some aspects of the present disclosure.

FIGS. 13A-13B are schematic diagrams illustrating resource configurations for transmitting a channel state information reference signal (CSI-RS) during an Rx beam training procedure in accordance with some aspects of the present disclosure.

FIGS. 14-15 are flow diagrams for UEs performing beam acquisition procedures in accordance with some aspects of the present disclosure.

FIGS. 16-17 are flow diagrams for UEs performing an Rx beam training procedure in accordance with some aspects of the present disclosure.

FIG. 18 is a block diagram illustrating a device that can be employed to perform SL beam management in accordance with some aspects of the present disclosure.

FIG. 19 is a block diagram illustrating baseband circuitry that can be employed to perform SL beam management in accordance with some aspects of the present disclosure.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Beamforming is a process that enables a signal to be transmitted or received in a particular spatial direction. During transmission, the phase and/or amplitude of a signal may be modified and provided to multiple antennas of an antenna array. When the antenna array transmits the modified signals, constructive and destructive interference occurs to form a combined signal. As a result of the constructive/destructive interference, the combined signal exhibits a stronger signal strength in a certain direction, thereby forming a “beam”.

Beamforming has several benefits, such as increased signal strength and reduced interference. For example, in higher frequency ranges (e.g., frequency range 2 (FR2)) where increased propagation loss is a concern, beamforming can be used to increase signal strength between a transmitter and a receiver to improve coverage. By concentrating the signal in the direction of a beam, the effects of propagation loss can be minimized. Furthermore, since the signal is mainly concentrated in the direction of the beam, the interference experienced by receivers in other directions is also minimized.

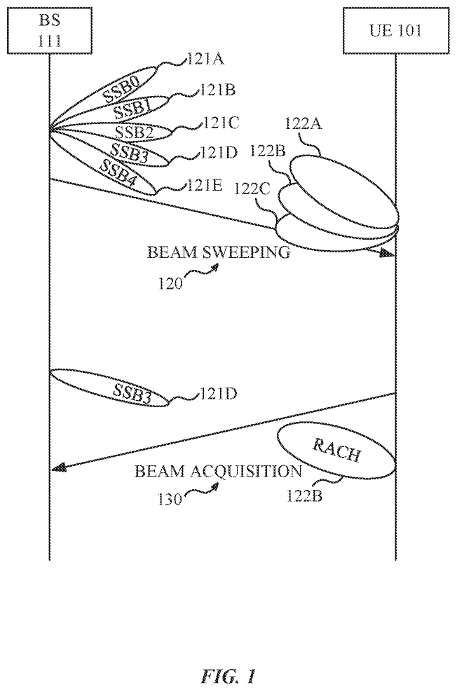

In order to utilize beamforming in wireless networks, a beam is first acquired. FIG. 1 illustrates a beam acquisition procedure between a base station 111 and a user equipment (UE) 101.

At act 120, the base station 111 sweeps its transmit (Tx) beam. The base station 111 transmits a plurality of synchronization signal blocks (SSBs) SSB0, SSB1, SSB2, SSB3, SSB4 on a plurality of respective beams 121A, 121B, 121C, 121D, 121E over time. For example, the base station 111 transmits SSB0 on beam 121A during a first time period, subsequently transmits SSB1 on beam 121B during a second time period, subsequently transmits SSB2 on beam 121C, etc. Simultaneously, the UE 101 sweeps its receive (Rx) beam. The UE 101 uses beams 122A, 122B, 122C to receive SSB0 on the beam 121A during the first time period. The process is then repeated for the beams 121B-121E until an “optimal” or “best” Tx/Rx beam pair is found. In the example of FIG. 1, the optimal beam combination is Tx beam 121D and Rx beam 122B.

At act 130, the optimal Tx beam is communicated in a beam acquisition message. The UE 101 sends the beam acquisition message indicating the Tx beam 121D as the optimal beam to the base station 111 during a random access channel (RACH) occasion. The RACH occasion may be associated with SSB3 that was transmitted on the Tx beam 121D. Based on the association, the base station 111 knows to monitor for the beam acquisition message during the RACH occasion using an Rx beam in the direction of the Tx beam 121D. Once the beam is acquired, it may be used for data transmission between the base station 111 and the UE 101.

In addition to communicating with a base station using uplink (UL) or downlink (DL) signaling, a UE may also communicate directly with other UEs using sidelink (SL) signaling.

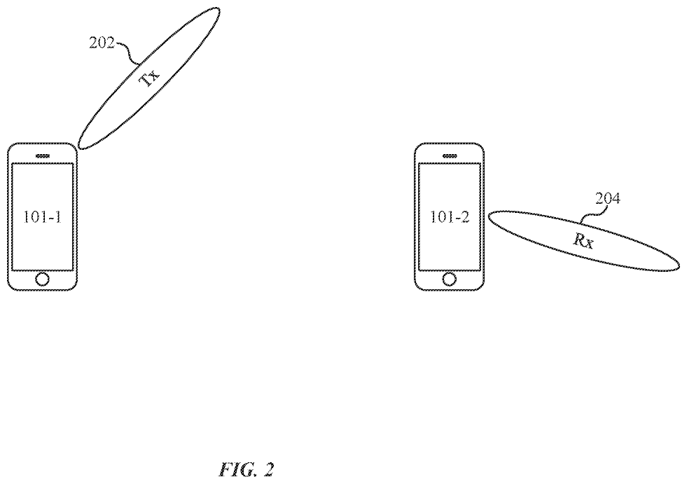

According to the current 3rd Generation Partnership Project (3GPP) specification, omni transmission and reception (e.g., using a wide antenna radiation pattern) is assumed for sidelink SL signaling and a mechanism for acquiring an optimal sidelink beam pair is not supported. Ignoring the effect of beamforming can result in misaligned Tx/Rx beams and ultimately cause transmission failure, as illustrated in FIG. 2.

FIG. 2 illustrates a first UE 101-1 and a second UE 101-2 attempting to communicate with one another via SL. The first UE 101-1 is transmitting using a Tx beam 202, and the second UE 101-2 is attempting to receive the transmission from the first UE 101-1 using an Rx beam 204. As illustrated, the Tx beam 202 and the Rx beam 204 are not aligned, which could result in failed transmission between the first UE 101-1 and the second UE 101-2.

Furthermore, due to differing requirements for SL communications when compared to UL/DL, the current 3GPP specification does not include RACH functionality in SL. Thus, while RACH transmission may be used for beam acquisition between a UE and a base station, an alternative method is desired for UEs performing beam acquisition in SL. Accordingly, the present disclosure provides techniques for providing a mechanism for acquiring an optimal sidelink beam pair by configuring a SL beam management resource pool that can be used for sending beam management messages in SL.

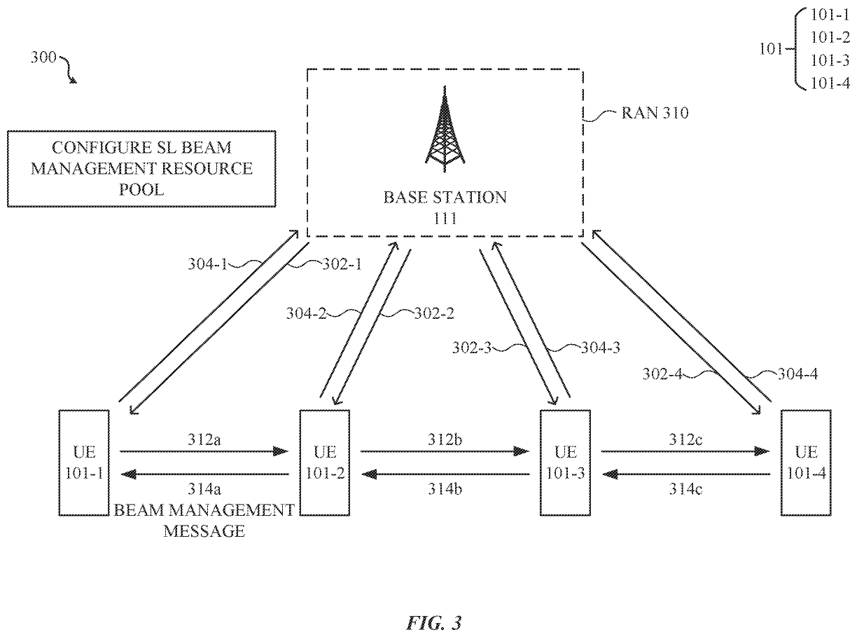

FIG. 3 illustrates an example architecture of a network system 300 in accordance with some aspects of the present disclosure. The network system 300 includes a plurality of UEs 101-1, 101-2, 101-3, and 101-4 (referred to collectively as “UEs 101”). The UEs 101 can be configured to connect, for example, or communicatively couple, with a RAN 310. The RAN 310 may comprise one or more base stations 111.

The UEs 101-1, 101-2, 101-3, and 101-4 may use connections (or channels) 304-1, 304-2, 304-3, and 304-4 for UL respectively, and connections (or channels) 302-1, 302-2, 302-3, and 302-4 for DL respectively. Furthermore, connections 312a, 312b, 312c and connections 314a, 314b, 314c may be used for SL communication between the UEs 101. For example, using connection 312a the UE 101-1 may receive data transmitted from the UE 101-2, and using connection 314a the UE 101-2 may receive data transmitted from the UE 101-1. Similar functionality can be inferred for the connections 312b, 314b, 312c, and 314c. Although not illustrated for simplicity, a UE of the UEs 101 may be capable of communicating with multiple UEs. For example, although a connection is not illustrated between the UE 101-1 and the UE 101-4, the UE 101-1 and the UE 101-4 may communicate with each other via their own SL connection.

The UEs 101 may comprise any mobile or non-mobile computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, Machine Type Communication (MTC) devices, Machine to Machine (M2M), Internet of Things (IoT) devices, and/or the like.

In some aspects, the RAN 310 can be a next generation (NG) RAN or a 5G RAN, an evolved-UMTS Terrestrial RAN (E-UTRAN), or a legacy RAN, such as a UTRAN or GERAN. As used herein, the term “NG RAN” or the like can refer to a RAN 310 that operates in an NR or 5G system, and the term “E-UTRAN” or the like can refer to a RAN 310 that operates in an LTE or 4G system.

Traditional UL/DL communication can involve many UEs communicating with a single base station, where the base station performs the UL/DL scheduling for the UEs. However, in SL, a large number of UEs may be communicating with one another with limited central scheduling (e.g., from a base station). In order to facilitate SL communications with a large number of UEs and limited central scheduling, resource pools may be configured or allocated for use in SL communication. A resource pool comprises a plurality of time frequency resources shared by SL UEs within a certain geographic area. Each of the UEs may monitor and reserve resources within the resource pool in a manner that minimizes interference and maximizes data throughput.

In some aspects, each of the UEs 101 receives a resource pool (pre) configuration. The resource pool (pre) configuration may be, for example, a resource pool configuration received from the base station 111, or a resource pool pre-configuration stored at the UE side. The resource pool pre-configuration may be used by a given UE when the UE is out of network coverage (e.g., out of range of the base station 111). Otherwise, the base station 111 may send the resource pool configuration to the UEs 101-1, 101-2, 101-3, 101-4 via channels 302-1, 302-2, 302-3, 302-4 respectively.

The resource pool (pre) configuration is used to configure a SL beam management resource pool. Time-frequency resources within the SL beam management resource pool may be used by a UE (e.g., UE 101-2) to transmit a beam management message to another UE (e.g., UE 101-1). In many examples herein, the beam management message is used to indicate a beam or provide signaling for an initial beam acquisition purposes. However, the beam management message, for example, may include a beam acquisition message, a beam failure recovery message, a beam maintenance message, a reference signal (RS) for beam measurement such as a channel state information reference signal (CSI-RS), and so on, that are transmitted at different times to maintain a beamformed SL link. In some aspects, resources in the SL beam management resource pool used to transmit the beam management message are selected based on an optimal beam determined by the UE. In some aspects, within the SL beam management resource pool, each of the UEs 101 may be configured with one or multiple CSI-RS resource sets to transmit beam management reference signals for beam measurement.

Within the SL beam management resource pool, each of the UEs 101 may be configured with one or multiple sidelink channels. The UEs 101 may be configured for physical sidelink control channel (PSCCH) and/or physical sidelink shared channel (PSSCH) transmissions within the SL beam management resource pool. The PSSCH transmissions, for example, may include related beam management messages. In some aspects, the beam management messages contain information such as S-SSB indexes and corresponding reference signal received power (RSRP) measurements, for example, during an initial beam acquisition procedure. In some aspects, the beam management messages contain information such as a candidate S-SSB index, a candidate CSI-RS resource index (CRI), and/or a potential RSRP, for example, during a beam failure recovery procedure. In some aspects, the beam management message includes information such as a CRI for beam acquisition, beam fine tuning, or beam maintenance. Transmissions on PSSCH including the above information may be carried, for example, by a medium access control (MAC) control element (MAC CE) or radio resource control (RRC) signaling.

In some aspects, each UE is allocated to a specific sub-channel of the SL beam management resource pool for transmitting PSCCH/PSSCH based on an UE identifier (ID). Alternatively, each UE may randomly select a sub-channel for transmitting PSCCH/PSSCH.

In some aspects, the SL beam management resource pool is configured on a per slot basis. However, in some alternative aspects, the SL beam management resource pool is configured using sub-slots (e.g., a 7 symbol slot) in order to increase resource pool efficiency (e.g., when the beam management message size is small). In the case of sub-slot configuration, an explicit association may be configured between a resource index and an S-SSB index. Further details of possible SL beam management resource pool configurations will now be described with reference to the following figures.

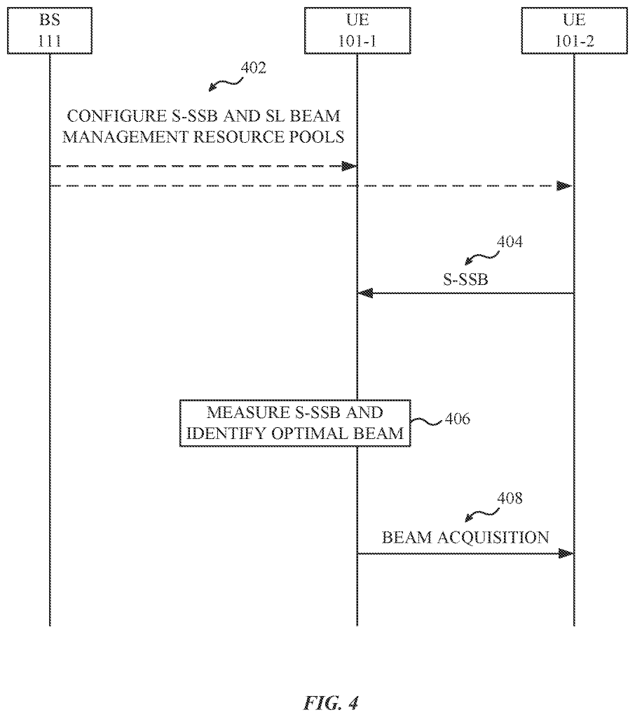

FIG. 4 illustrates an example beam acquisition procedure between two SL UEs in accordance with some aspects of the present disclosure.

At act 402, a UE 101-1 and a UE 101-2 receive a resource pool (pre) configuration. The resource pool (pre) configuration may be, for example, a resource pool configuration transmitted by a base station 111, or a resource pool pre-configuration stored at the UE side. The resource pool (pre) configuration includes resource pool information indicating a sidelink SSB (S-SSB) resource pool and a SL beam management resource pool. Although FIG. 4 illustrates a single configuration message, the S-SSB resource pool and the SL beam management resource pool may alternatively be configured by different configuration messages. In some aspects, the base station 111 further configures the UE 101-1 and the UE 101-2 with a data transmission resource pool. The SL beam management resource pool, S-SSB resource pool, and data transmission resource pool may be, for example, multiplexed in a time division multiplexing (TDM) manner.

At act 404, the UE 101-2 transmits a plurality of S-SSBs to the UE 101-1 on a plurality of respective beams using resources in the S-SSB resource pool.

At act 406, the UE 101-1 measures the plurality of S-SSBs and identifies an optimal beam of the plurality of respective beams.

At act 408, the UE 101-1 transmits a beam management message, more specifically a beam acquisition message, to the UE 101-2 using resources in the SL beam management resource pool. In some aspects, the beam acquisition message indicates an index of the optimal beam.

Although the process of FIG. 4 is described in the present example as a beam acquisition procedure, it may alternatively be performed as part of a beam failure recovery procedure or another type of beam management procedure. For example, the process of FIG. 4 may be triggered by a beam failure, or at any other time an optimal SL beam should be selected.

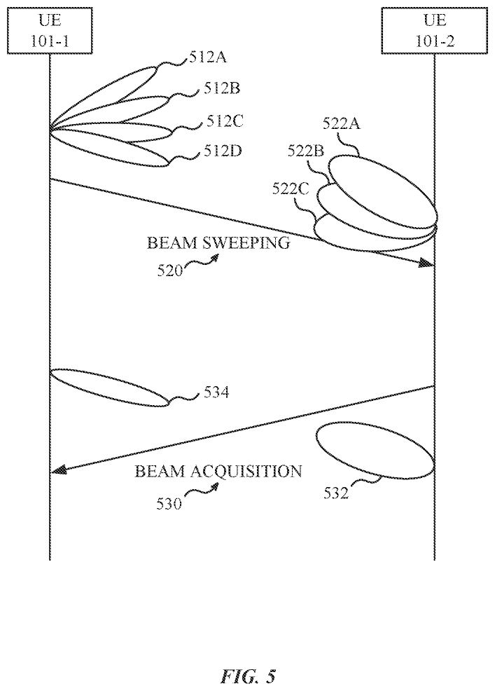

FIG. 5 illustrates a beam acquisition procedure which may be, for example, another perspective of the beam acquisition procedure of FIG. 4.

In some aspects, beam sweeping is performed at act 520. The UE 101-1 transmits S-SSBs on the Tx beams 512A, 512B, 512C, 512D respectively, which may, for example, correspond to act 404 of FIG. 4. The UE 101-2 measures the plurality of S-SSBs and identifies an optimal beam, which may, for example, correspond to act 406 of FIG. 4. Identifying the optimal beam may include, for example, measuring the S-SSBs on each of the beams and comparing RSRP measurements or another type of measurement. The UE 101-2 may optionally sweep its own Rx beam by measuring each respective S-SSB using a plurality of Rx beams 522A, 522B, 522C. In the illustrated example, the optimal beam pair includes the Tx beam 512D and the Rx beam 522B.

In some aspects, beam acquisition is performed at act 530. The UE 101-2 transmits a beam acquisition message to the UE 101-1 indicating the Tx beam 512D as the optimal beam, which may, for example, correspond to act 408 of FIG. 4. In some aspects, the UE 101-2 transmits the beam acquisition message using resources in the SL beam management resource pool on a beam 532 in a same direction as the optimal Rx beam 522B, and the UE 101-1 receives the beam acquisition message using the resources in the SL beam management resource pool on a beam 534 in a same direction as the optimal Tx beam 512D.

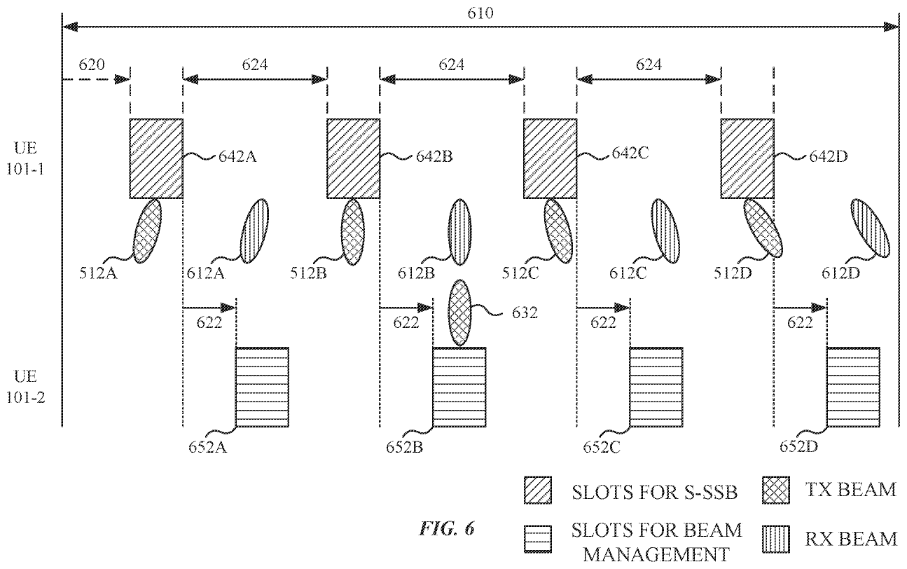

FIG. 6 illustrates an example resource pool configuration for beamed transmission and beamed receiving in accordance with some aspects of the present disclosure. An S-SSB resource pool and a SL beam management resource pool are configured for a first UE 101-1 and a second UE 101-2. The S-SSB resource pool is configured using a periodicity, offset, and interval, and the SL beam management resource pool is configured using an offset from the S-SSB resource pool.

The S-SSB resource pool may be configured, for example, using a resource pool (pre) configuration as described with reference to FIGS. 3-4. The configured S-SSB resource pool includes resources 642A, 642B, 642C, 642D. The resource 642A occurs in the time after an offset 620 from a start of a period 610. As used herein, the term “resource” may be understood to refer to a set of time-frequency resources (e.g., within a resource pool). In some aspects, the time resources of a “resource” are continuous.

The period 610 repeats according to the configured periodicity. The periodicity may be, for example, 160 milliseconds (ms). Furthermore, an interval 624 is configured between the resources 642A, 642B, 642C, 642D. The resources 642A, 642B, 642C, 642D of the S-SSB resource pool are used to transmit a plurality of S-SSBs on a respective plurality of beams 512A, 512B, 512C, 512D.

The SL beam management resource pool may be configured, for example, using a resource pool (pre) configuration as described with reference to FIGS. 3-4. The configured SL beam management resource pool includes resources 652A, 652B, 652C, 652D, which occur in time after an offset 622 from the resources 642A, 642B, 642C, 642D of the S-SSB resource pool respectively. The offset 622 may be related to a processing time. The offset 622 may, for example, have a duration of one slot or another suitable value. The resources 652A, 652B, 652C, 652D are used for respective beam acquisition messages for the S-SSBs transmitted using resources 642A, 642B, 642C, 642D. A beam acquisition message for a given S-SSB may be used to indicate that the S-SSB is associated with an optimal beam. In some aspects, the UE 101-1 monitors the resources 652A, 652B, 652C, 652D using beams 612A, 612B, 612C, 612D respectively. In some aspects, the beams 612A, 612B, 612C, 612D are in the same direction as the beams associated with the S-SSBs corresponding to the respective beam acquisition message (e.g., the beams 512A, 512B, 512C, 512D respectively).

The UE 101-1 transmits, and the UE 101-2 receives, the plurality of S-SSBs on the respective plurality of beams 512A, 512B, 512C, 512D. The UE 101-2 measures each of the plurality of S-SSBs to determine an optimal beam of the plurality of beams 512A, 512B, 512C, 512D (e.g., as in act 520 of FIG. 5). In some additional aspects, if the UE 101-2 is capable of Rx beamforming, the UE 101-2 may simultaneously sweep its Rx beam to determine an optimal Rx beam. In the example of FIG. 6, the UE 101-2 determines that the beam 512B is the optimal Tx beam. In response, the UE 101-2 transmits a beam acquisition message using resource 652B, which is received by the UE 101-1 (e.g., as in act 530 of FIG. 5). Since SL communication is performed between UEs, which may have a similar number of antennas and beam settings, it is likely that a similar number of Tx/Rx beams can be used by different UEs, which results in efficient use of the resource pool.

In FIG. 6 there is a one-to-one correspondence between the number of S-SSBs and resources in the configured SL beam management resource pool. Configuring a separate resource in the SL beam management resource pool for each S-SSB resource in the S-SSB resource pool provides several advantages. Since there is a 1:1 mapping between each S-SSB and resource for receiving a corresponding beam acquisition message, the beam acquisition message may be transmitted by the UE 101-2 and received by the UE 101-1 using respective Tx/Rx beams in a same direction as the corresponding S-SSB beam. In the example of a beam acquisition message, the beam acquisition message is transmitted using a beam 632 and received using the beam 612B, which are both in a same direction as the optimal beam 512B. This means that UE 101-1 is already tuned to the direction of the Rx beam for receiving the beam acquisition message. Based on the association between the resource 642B and the resource 652B, the UE 101-1 knows to monitor the resource 652B using the beam 612B. The UE 101-1 knowing when to monitor and also what beam to monitor is important in order to ensure accurate transmission/reception of the beam acquisition message, since misaligned Tx/Rx beams could ultimately result in failed transmission (e.g., as shown in FIG. 2).

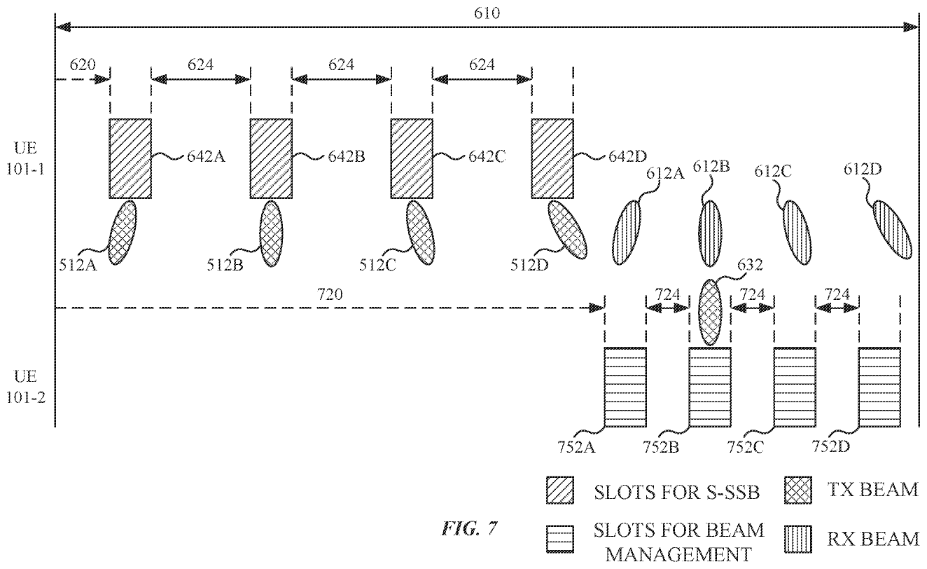

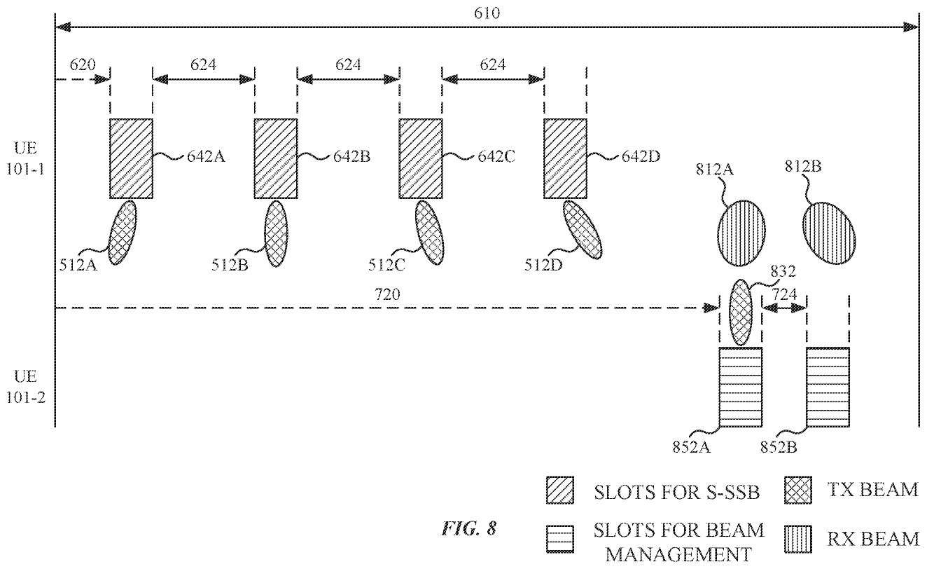

FIGS. 7-8 illustrate example resource pool configurations for beamed transmission and beamed receiving in accordance with some aspects of the present disclosure. An S-SSB resource pool and a SL beam management resource pool are configured for a first UE 101-1 and a second UE 101-2. As in the example illustrated in FIG. 6, the S-SSB resource pool is configured using a first periodicity, first offset 620, and first interval 624. However, rather than being configured based on an offset from the S-SSB resources, the SL beam management resource pool is configured using a second periodicity, a second offset 720, and a second interval 724.

In some aspects, the second periodicity is the same as the first periodicity, such that the S-SSB resource pool and the SL beam management resource pool share the period 610. The second offset 720 and the second interval 724 may be configured flexibly.

As illustrated in FIG. 7, the SL beam management resource pool is configured with resources 752A, 752B, 752C, 752D. This results in a 1:1 mapping between S-SSB and beam acquisition message resource. In some aspects, the mapping is specified by an explicit association between respective indexes of the resources 752A, 752B, 752C, 752D and respective S-SSB indexes. The explicit association may be included, for example, in the resource pool (pre) configuration. In the example of FIG. 7, the UE 101-2 determines the beam 512B to be the optimal beam and transmits a beam management message, specifically a beam acquisition message, using resource 752B on the beam 632. The UE 101-1 may receive the beam acquisition message using the resource 752B on the beam 612B.

Configuring the SL beam management resource pool using periodicity, offset, and interval provides greater flexibility. As illustrated in FIG. 7, a 1:1 mapping between S-SSB and beam acquisition message resource may be configured, similar to the example of FIG. 6, but with the SL beam management resources clustered in the time domain. The UE may measure all of the S-SSBs and determine the optimal S-SSB, and reply within the period 610, which may reduce the amount of time used for beam acquisition.

As illustrated in FIG. 8, a multiple to one mapping between S-SSB and beam acquisition message resource may be configured, which allows a granularity of the beam sweeping to be adjusted. FIG. 8 illustrates the SL beam management resource pool configured with resources 852A and 852B. S-SSBs transmitted on beams 512A, 512B are mapped to the resource 852A, and S-SSBs transmitted on beams 512C, 512D are mapped to the resource 852B. In the example of FIG. 8, the UE 101-2 determines a beam 812A is the optimal beam. As a result, the UE 101-2 transmits a beam acquisition message indicating the optimal beam 812A using the resource 852A on a beam 832, and the UE 101-1 receives the beam acquisition message using the resource 852A on the beam 812A. The beam 812A corresponds to a combination of the beams 512A, 512B and a beam 812B corresponds to a combination of the beams 5120, 512D. As a result of the multiple to one mapping, the beams 812A, 812B are wider than the beams 512A, 512B, 512C, 512D, and the time domain resources used for monitoring for beam management messages is reduced by half as compared to the example of FIG. 7. In some aspects, the mapping is specified by an explicit association between an index of each of the resources 852A, 852B and the S-SSB indexes which may be, for example, included in the SL beam management resource pool (pre) configuration.

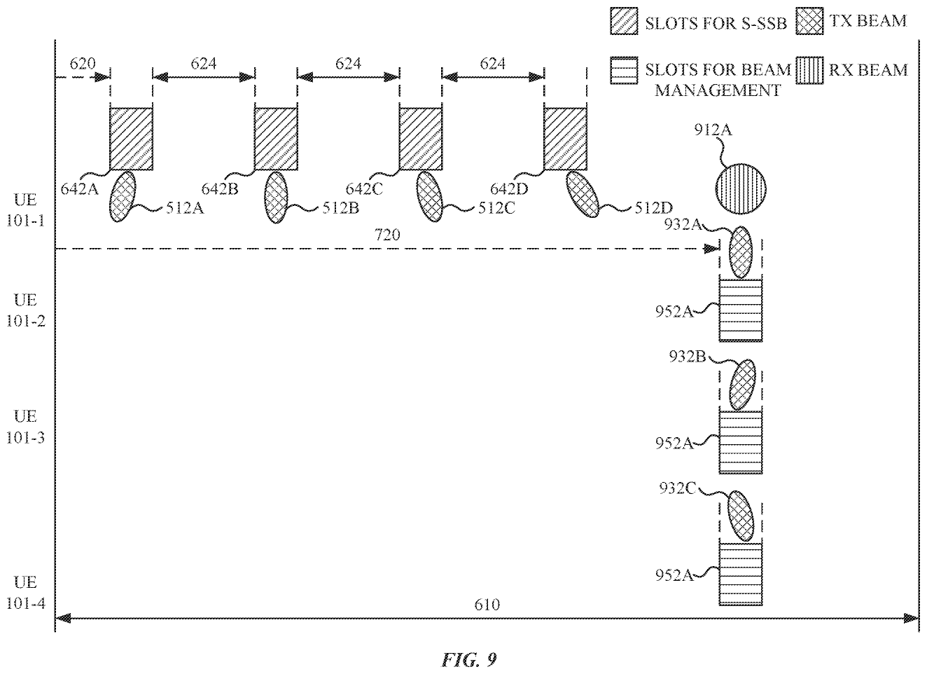

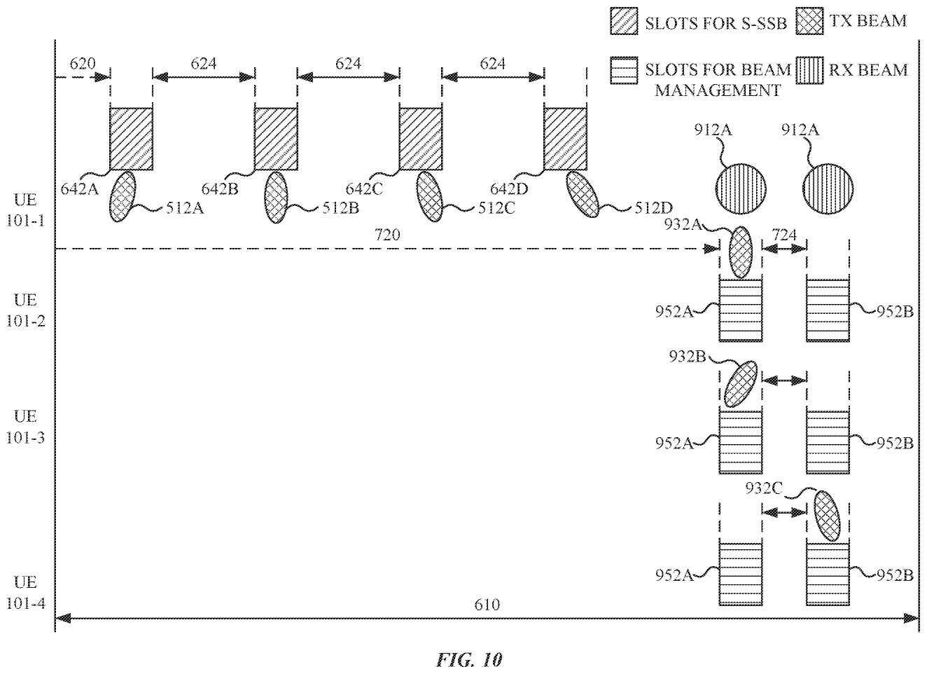

FIGS. 9-10 illustrate example resource pool configurations for beamed transmission and quasi-omni receiving in accordance with some aspects of the present disclosure. An S-SSB resource pool and a SL beam management resource pool are configured for a first UE 101-1, a second UE 101-2, a third UE 101-3, and a fourth UE 101-4. The S-SSB resource pool is configured using a first periodicity, first offset 620, and first interval 624, and the SL beam management resource pool is configured using a second periodicity, a second offset 720, and a second interval 724. In some aspects, the second periodicity is the same as the first periodicity, such that the S-SSB resource pool and the SL beam management resource pool share a period 610.

The S-SSB resource pool of FIGS. 9-10 resembles the S-SSB resource pool of the examples illustrated in FIGS. 6-8. The SL beam management resource pool of FIG. 9 differs from the examples of FIGS. 6-8 in that the SL beam management resource pool comprises a single resource 952A, which is associated with S-SSBs or beams 512A, 512B, 512c, 512D. The UE 101-1 is configured to receive beam management messages with a quasi-omni beam 912A using the resource 952A. By using the quasi-omni beam 912A, the UE 101-1 is able to receive beam management messages that were transmitted using multiple beams from different directions at the same time using the resource 952A.

For example, the second UE 101-2, third UE 101-3, and fourth UE 101-4 each measure the plurality of SSBs to determine the beam 512B, the beam 512A, and the beam 512C to be the optimal beam respectively. The second UE 101-2, third UE 101-3, and fourth UE 101-4 each transmit a beam acquisition message indicating the corresponding optimal beam to the first UE 101-1 using beams 932A, 932B, 932C respectively. Coding and/or modulation of the beam acquisition messages may be used to indicate which UE transmitted a beam acquisition message. By using the quasi-omni beam 912A, the first UE 101-1 is able to receive the beam acquisition messages from the UEs 101-2, 101-3, 101-4 using the resource 952A despite the beams 932A, 932B, 932C being in different directions.

As illustrated in FIG. 10, the SL beam management resource pool may be configured to include additional resources such as a resource 952B in order to reduce the possibility of interference. For example, upon determining an optimal beam, each UE of the UEs 101-2-, 101-3, 101-4 may randomly select one of the resources for transmitting the respective beam acquisition message. In the example of FIG. 10, the second UE 101-2 and the third UE 101-3 randomly select the resource 952A for transmission, and the fourth UE 101-4 randomly selects the resource 952B for transmission. The possibility of interference is thereby reduced compared to FIG. 9, since the transmission load is spread across the resources 952A, 952B.

The quasi-omni beam 912A provides flexibility to use either a 1:1 or multiple to one mapping for S-SSB to response resource. Further, since the UE 101-1 can receive from multiple other UEs transmitting on different beams within the same slot, efficiency is thereby increased.

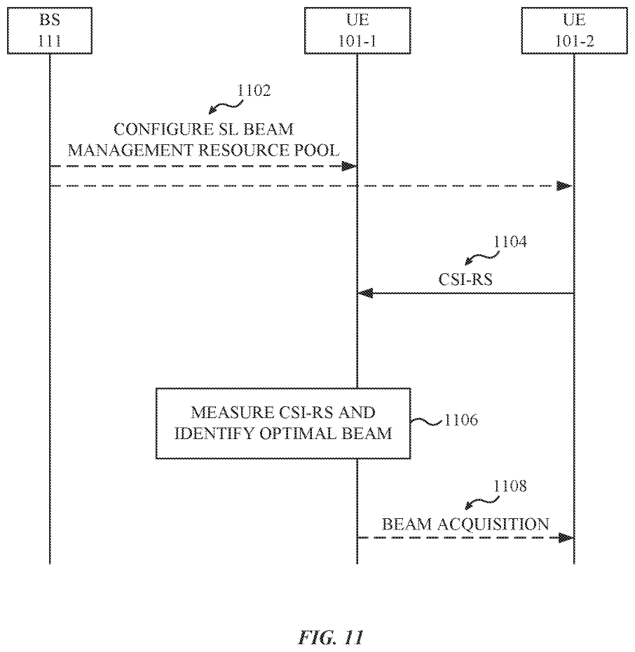

FIG. 11 illustrates a beam management procedure between two SL UEs in accordance with some aspects of the present disclosure.

At act 1102, a UE 101-1 and a UE 101-2 receive a resource pool (pre) configuration. The resource pool (pre) configuration may be, for example, a resource pool configuration transmitted by a base station 111, or a resource pool pre-configuration stored at the UE side. The resource pool (pre) configuration includes resource pool information indicating a SL beam management resource pool.

In one example, FIG. 11 corresponds to a beam acquisition procedure or the like (e.g., as described with reference to FIG. 4). At act 1104, the UE 101-2 transmits a plurality of CSI-RSs to the UE 101-1 using resources in the SL beam management resource pool. The plurality of CSI-RSs are transmitted on a respective plurality of beams.

At act 1106, the UE 101-1 measures the plurality of CSI-RSs and determines an optimal beam of the plurality of beams.

At act 1108, the UE 101-1 transmits a beam management message, more specifically a beam acquisition message, to the UE 101-2 using resources in the SL beam management resource pool. In some aspects, the beam acquisition messages indicates an index of the optimal beam.

In another example, FIG. 11 corresponds to an Rx beam training procedure. At act 1104, the UE 101-2 transmits a plurality of CSI-RSs to the UE 101-1 using resources in the SL beam management resource pool. The plurality of CSI-RSs are transmitted on a same beam. For example, CSI-RS repetition ON may be configured.

At act 1106, the UE 101-1 measures the plurality of CSI-RSs (on the same beam) received from the UE 101-2 while simultaneously sweeping its own Rx beam to identify an optimal Rx beam. This optimal beam may be used by the UE 101-1 to receive SL transmissions from the UE 101-2 or a corresponding Tx beam to the optimal Rx beam may be used to transmit SL transmissions to the UE 101-2.

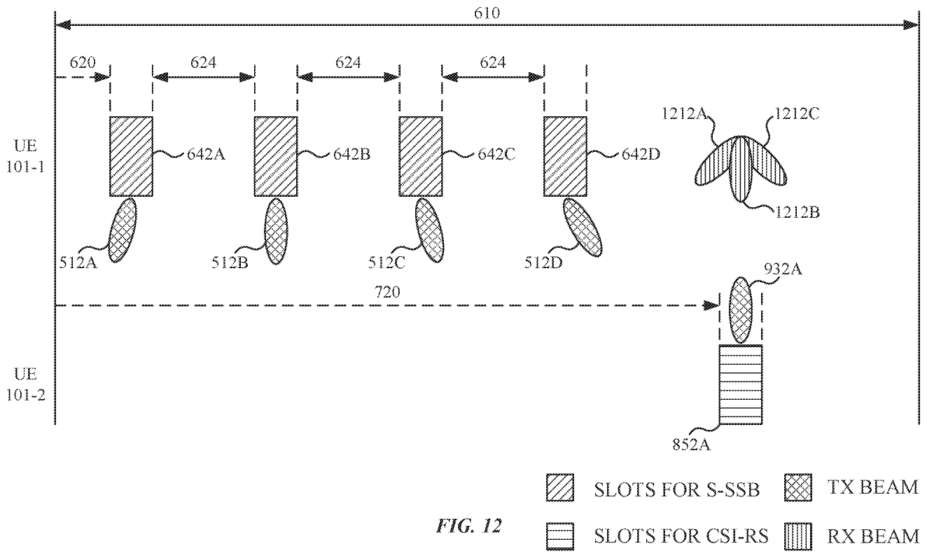

FIG. 12 illustrates a SL beam management resource pool configuration for an Rx beam training procedure in accordance with some aspects of the present disclosure. In some aspects, the Rx beam training procedure is performed after the beam acquisition procedure previously described with reference to FIGS. 4-10. In some aspects, the SL beam management resource pool is configured using an offset with respect to configured S-SSBs or using a periodicity, offset, and interval.

The S-SSB resource pool of FIG. 12 resembles the S-SSB resource pool of FIGS. 6-10. Similar to the example of FIG. 9, the SL beam management resource pool is illustrated with an offset 720, and shares a period 610 with the S-SSB resource pool. However, the example of FIG. 12 differs from the example of FIG. 9 in that the SL beam management pool in FIG. 12 is configured for CSI-RS transmission. In one example, the Rx beam training procedure of FIG. 12 is performed after the beam acquisition procedure of FIG. 9. In an alternative example, the Rx beam training procedure of FIG. 12 is performed alone. The UE transmits a plurality of CSI-RSs on the beam 932A using the resource 852A. The resource 852A, for example, may have a duration of one slot. CSI-RS repetition ON may be configured in order to achieved repeated CSI-RS transmission on the beam 932A. The UE 101-1 performs Rx beam sweeping, including measuring the CSI-RSs using Rx beams 1212A, 1212B, 1212C to determine an optimal Rx beam. The UE 101-1 then may use a Tx beam corresponding to the optimal Rx beam to transmit sidelink transmissions to the UE 101-2. In some aspects, different CSI-RS ports are configured per each OFDM symbol of the CSI-RS transmission. In some aspects, a maximum number of CSI-RS ports are configured. In some aspects, a different Rx beam is used by the UE 101-1 to receive each CSI-RS symbol within a slot.

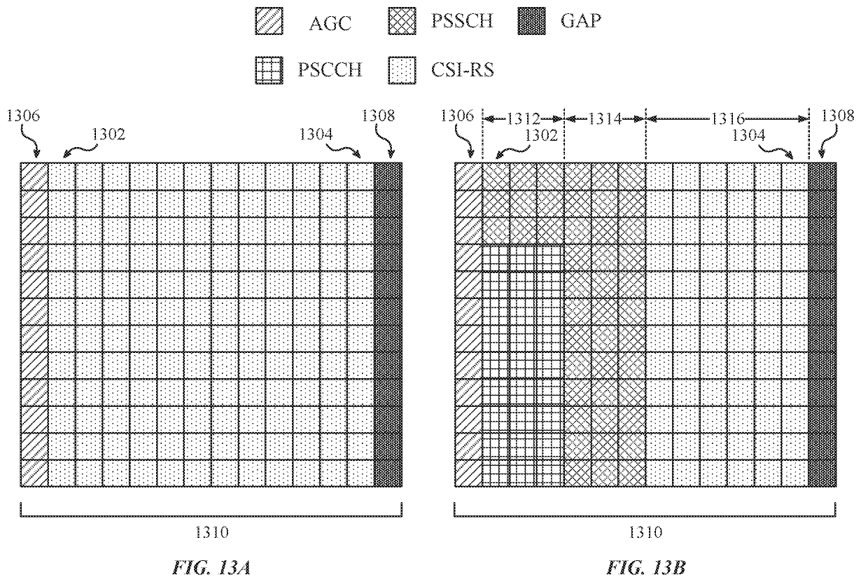

FIGS. 13A-13B illustrate resource configurations for transmitting CSI-RS during an Rx beam training procedure in accordance with some aspects of the present disclosure.

As illustrated in FIG. 13A, when a slot does not include PSCCH or PSSCH, the CSI-RS can be transmitted from a symbol 1302 (e.g., symbol 1) to a symbol 1304 (e.g., symbol 12) of a slot 1310. A symbol 1306 (e.g., symbol 0) of the slot 1310 is configured for automatic gain control (AGC), and a symbol 1308 (e.g., symbol 13) of the slot 1310 is configured as a gap symbol.

FIG. 13B illustrates a configuration for a slot that includes PSSCH and PSCCH. In this example, the CSI-RS can be transmitted during a sub-set of symbols ranging from the symbol 1302 to the symbol 1304. As illustrated, a range of symbols 1312 is configured partially for PSSCH transmissions and partially for PSCCH transmissions. A range of symbols 1314 is configured for PSSCH transmissions, and a range of symbols 1316 is configured for CSI-RS transmission. The present example is merely illustrative. It is appreciated that any sub-set (continuous or non-continuous) ranging from the symbol 1302 to the symbol 1304 may alternatively be used to transmit CSI-RS.

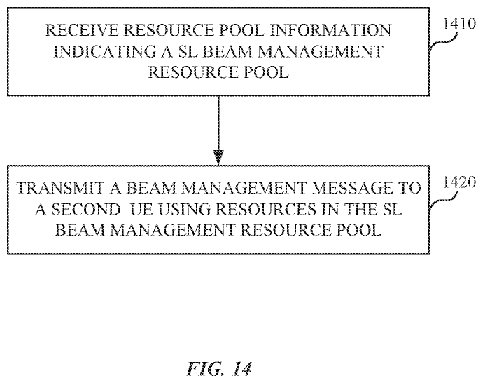

FIG. 14 is a flow diagram for a UE to perform a beam management procedure in accordance with some aspects of the present disclosure. The UE of FIG. 14, for example, may correspond to the UE 101-2 from any one of FIGS. 6-10.

At step 1410, the UE receives resource pool information indicating a SL beam management resource pool.

At step 1420, the UE transmits a beam management message to a second UE using resources in the SL beam management resource pool. The beam management message may include, but is not limited to, a beam acquisition message, a beam failure recovery message, etc.

In some examples, the beam management message indicates an optimal beam of a plurality of beams. The plurality of beams may be associated with a plurality of S-SSBs or CSI-RSs received by the UE. The UE may receive the S-SSBs or CSI-RSs on the plurality of beams and measure the S-SSBs or CSI-RSs to determine the optimal beam.

In the example of S-SSB, the resource pool information may further indicate an S-SSB resource pool, and the S-SSBs may be received using resources in the S-SSB resource pool.

In the example of CSI-RS, the UE may further receive a configuration message to configure the SL beam management resource pool for CSI-RS transmission. The configuration message may be included in, for example, RRC signaling or the like.

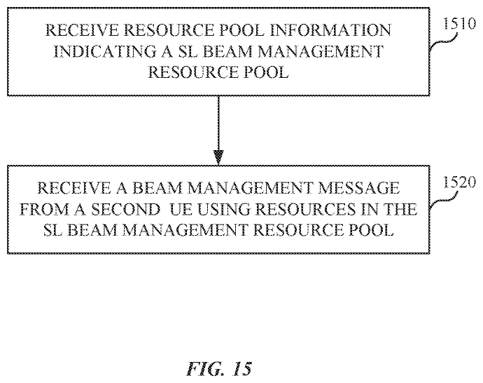

FIG. 15 is a flow diagram for a UE to perform a beam management procedure in accordance with some aspects of the present disclosure. The UE of FIG. 15, for example, may correspond to the UE 101-1 from any one of FIGS. 6-10.

At step 1510, the UE receives resource pool information indicating a SL beam management resource pool.

At step 1520, the UE receives a beam management message from a second UE using resources in the SL beam management resource pool. The beam management message may include, but is not limited to, a beam acquisition message, a beam failure recovery message, etc. In some aspects, the beam management message indicates an optimal beam of a plurality of beams. The UE may, for example, transmit a plurality of S-SSBs or a plurality of CSI-RSs to the second UE on the plurality of beams respectively before performing step 1520.

In the example of S-SSB, the resource pool information may further indicate an S-SSB resource pool, and the S-SSBs may be received using resources in the S-SSB resource pool.

In the example of CSI-RS, the UE may further receive a configuration message to configure the SL beam management resource pool for CSI-RS transmission. The configuration message may be included in, for example, RRC signaling or the like.

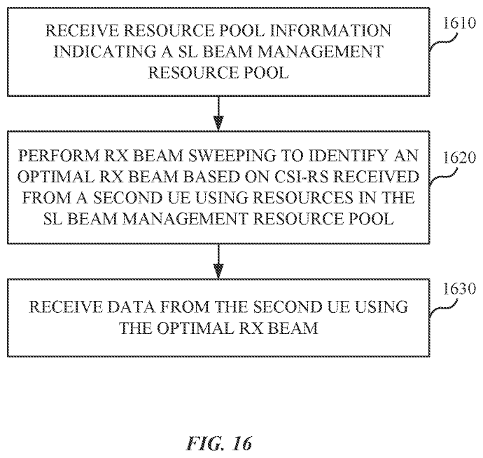

FIG. 16 is a flow diagram for a UE performing an Rx beam training procedure in accordance with some aspects of the present disclosure. The UE of FIG. 16, for example, may correspond to the UE 101-1 of FIG. 12.

At step 1610, the UE receives resource pool information indicating a SL beam management resource pool. In some aspects, the UE receives a configuration message to configure the SL beam management resource pool for CSI-RS transmission. The configuration message may be included in, for example, RRC signaling or the like.

At step 1620, the UE performs Rx beam sweeping to identify an optimal Rx beam based on CSI-RS received from a second UE. In some aspects, the beam sweeping includes receiving a plurality of CSI-RSs from the second UE using resources in the SL beam management resource pool, and measuring the plurality of CSI-RSs using different Rx beams. In some aspects, the CSI-RS is configured with repetition ON (e.g., the second UE transmits the CSI-RSs on a single beam).

At step 1630, the UE receives data from the second UE using the optimal Rx beam.

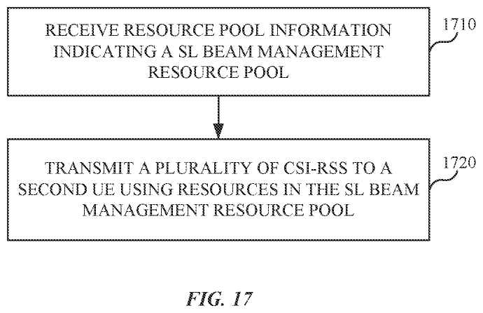

FIG. 17 is a flow diagram for a UE performing an Rx beam training procedure in accordance with some aspects of the present disclosure. The UE of FIG. 17, for example, may correspond to the UE 101-2 of FIG. 12.

At step 1710, the UE receives resource pool information indicating a SL beam management resource pool. In some aspects, the UE receives a configuration message to configure the SL beam management resource pool for CSI-RS transmission. The configuration message may be included in, for example, RRC signaling or the like.

At step 1720, the UE transmits a plurality of CSI-RSs to a second UE using resources in the SL beam management resource pool. In some aspects, the CSI-RS is configured with repetition ON. In some aspects, the CSI-RS is transmitted from a sub-set of symbols ranging from symbol 1 to symbol 12 of a slot (e.g., as shown in FIGS. 13A-13B).

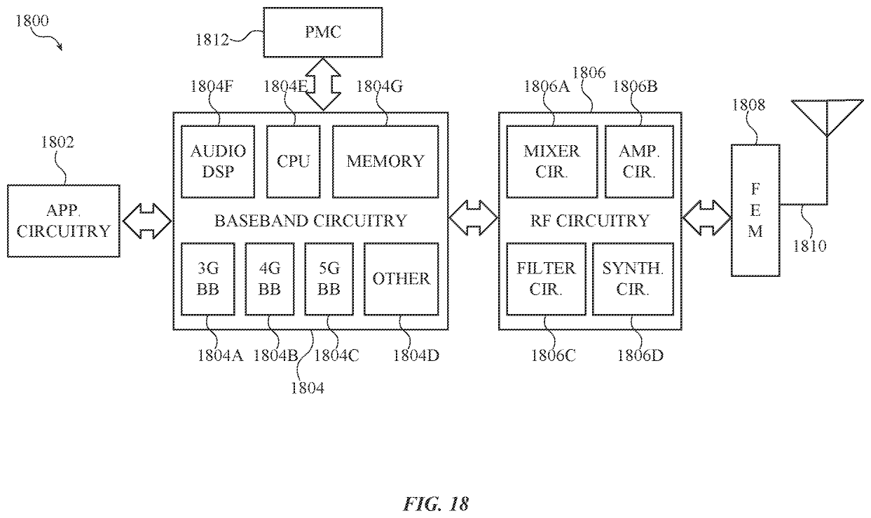

FIG. 18 is a diagram illustrating example components of a device 1800 that can be employed in accordance with some aspects of the present disclosure. In some aspects, the device 1800 can include application circuitry 1802, baseband circuitry 1804, Radio Frequency (RF) circuitry 1806, front-end module (FEM) circuitry 1808, one or more antennas 1810, and power management circuitry (PMC) 1812 coupled together at least as shown. The components of the illustrated device 1800 can be included in a UE or a RAN node such as the UE 101 or the base station 111 as described, for example, with reference to FIGS. 3-4 and throughout the present disclosure. The UE 101 may be configured by the base station 111 to utilize a SL beam management resource pool for transmitting beam management messages, as described throughout the present disclosure. In some implementations, the device 1800 can include fewer elements (e.g., a RAN node may not utilize application circuitry 1802 and instead include a processor/controller to process IP data received from a CN, which may be a 5GC or an Evolved Packet Core (EPC)). In some implementations, the device 1800 can include additional elements such as, for example, memory/storage, display, camera, sensor (including one or more temperature sensors, such as a single temperature sensor, a plurality of temperature sensors at different locations in device 1800, etc.), or input/output (I/O) interface. In other implementations, the components described below can be included in more than one device (e.g., said circuitries can be separately included in more than one device for Cloud-RAN (C-RAN) implementations).

The application circuitry 1802 can include one or more application processors. For example, the application circuitry 1802 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1800. In some implementations, processors of application circuitry 1802 can process IP data packets received from an EPC.

The baseband circuitry 1804 can include circuitry such as, but not limited to, one or more single-core or multi-core processors. The baseband circuitry 1804 can include one or more baseband processors or control logic to process baseband signals received from a receive signal path of the RF circuitry 1806 and to generate baseband signals for a transmit signal path of the RF circuitry 1806. Baseband circuitry 1804 can interface with the application circuitry 1802 for generation and processing of the baseband signals and for controlling operations of the RF circuitry 1806. For example, in some implementations, the baseband circuitry 1804 can include a 3G baseband processor 1804A, a 4G baseband processor 1804B, a 5G baseband processor 1804C, or other baseband processor(s) 1804D for other existing generations, generations in development or to be developed in the future (e.g., 2G, 6G, etc.).

The baseband circuitry 1804 (e.g., one or more of baseband processors 1804A-D) can handle various radio control functions that enable communication with one or more radio networks via the RF circuitry 1806. In other implementations, some or all of the functionality of baseband processors 1804A-D can be included in modules stored in the memory 1804G and executed via a Central Processing Unit (CPU) 1804E. The radio control functions can include, but are not limited to, signal modulation/demodulation, encoding/decoding, radio frequency shifting, etc. In some implementations, the baseband circuitry 1804 can include one or more audio digital signal processor(s) (DSP) 1804F.

RF circuitry 1806 can enable communication with wireless networks using modulated electromagnetic radiation through a non-solid medium. In various implementations, the RF circuitry 1806 can include switches, filters, amplifiers, etc. to facilitate the communication with the wireless network. RF circuitry 1806 can include a receive signal path which can include circuitry to down-convert RF signals received from the FEM circuitry 1808 and provide baseband signals to the baseband circuitry 1804. RF circuitry 1806 can also include a transmit signal path which can include circuitry to up-convert baseband signals provided by the baseband circuitry 1804 and provide RF output signals to the FEM circuitry 1808 for transmission.

In some implementations, the receive signal path of the RF circuitry 1806 can include mixer circuitry 1806A, amplifier circuitry 1806B and filter circuitry 1806C. In some implementations, the transmit signal path of the RF circuitry 1806 can include filter circuitry 1806C and mixer circuitry 1806A. RF circuitry 1806 can also include synthesizer circuitry 1806D for synthesizing a frequency for use by the mixer circuitry 1806A of the receive signal path and the transmit signal path.

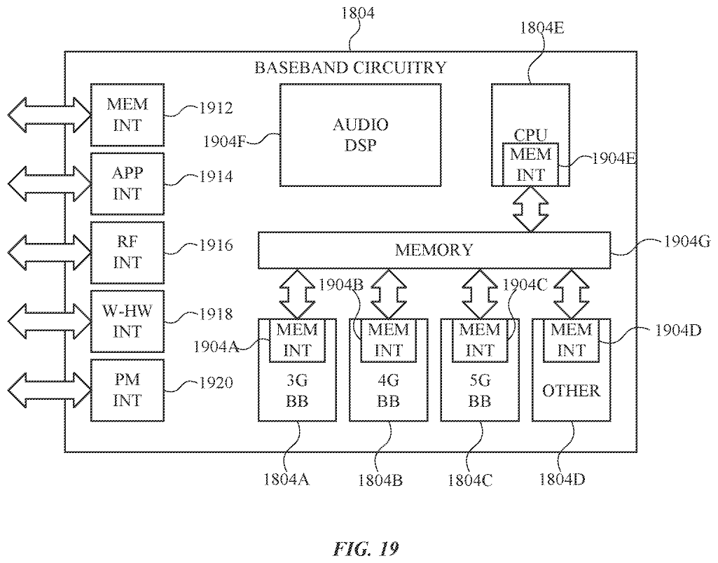

FIG. 19 illustrates a diagram illustrating example interfaces of baseband circuitry that can be employed in accordance with some aspects. As discussed above, the baseband circuitry 1804 of FIG. 18 can comprise processors 1804A-1804E and a memory 1804G utilized by said processors. Each of the processors 1804A-1804E can include a memory interface, 1904A-1904E, respectively, to send/receive data to/from the memory 1804G. The baseband circuitry 1804, or the one or more baseband processors or control logic of the baseband circuitry 1804, may stand alone as the UE 101 or the base station 111, and perform signaling and operation in the meaning as described throughout this disclosure.

The baseband circuitry 1804 can further include one or more interfaces to communicatively couple to other circuitries/devices, such as a memory interface 1912 (e.g., an interface to send/receive data to/from memory external to the baseband circuitry 1804), an application circuitry interface 1914 (e.g., an interface to send/receive data to/from the application circuitry 1802 of FIG. 18), an RF circuitry interface 1916 (e.g., an interface to send/receive data to/from RF circuitry 1806 of FIG. 18), a wireless hardware connectivity interface 1918 (e.g., an interface to send/receive data to/from Near Field Communication (NFC) components, Bluetooth® components (e.g., Bluetooth® Low Energy), Wi-Fi® components, and other communication components), and a power management interface 1920 (e.g., an interface to send/receive power or control signals to/from the PMC 1812).

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

Example 1 is a baseband processor for a user equipment (UE). The baseband processor comprises a memory and one or more processors coupled to the memory. The one or more processors are configured to execute instructions stored in the memory to cause the UE to: receive resource pool information indicating a sidelink (SL) beam management resource pool, and transmit a beam management message to a second UE using resources in the SL beam management resource pool.

Example 2 comprises any variation of example 1, wherein the resource pool information includes resource pool configuration information indicating a time offset between a SL synchronization signal block (S-SSB) resource pool and the SL beam management resource pool.

Example 3 comprises any variation of example 1, wherein the resource pool information includes resource pool configuration information indicating an association between one or more S-SSB indexes and a resource index of the SL beam management resource pool.

Example 4 comprises any variation of example 1, wherein the resource pool information includes resource pool configuration information indicating an offset, interval, and periodicity of the SL beam management resource pool.

Example 5 comprises any variation of example 4, wherein the periodicity of the SL beam management resource pool is the same as a periodicity of an SL synchronization signal block (S-SSB) resource pool.

Example 6 comprises any variation of example 1, wherein resources in the SL beam management resource pool are multiplexed in a time division multiplexing (TDM) manner with resources in an S-SSB resource pool and resources in a SL data transmission resource pool.

Example 7 comprises any variation of example 1, wherein the resource pool information configures the SL beam management resource pool on a per slot basis.

Example 8 comprises any variation of example 1, wherein the resource pool information configures the SL beam management resource pool on a per sub-slot basis.

Example 9 comprises any variation of example 1, wherein the one or more processors further cause the UE to transmit the beam management message in a medium access control (MAC) control element (CE) on a physical sidelink shared channel (PSSCH).

Example 10 comprises any variation of example 1, wherein the one or more processors further cause the UE to: measure a plurality of SL synchronization signal blocks (S-SSBs) received from the second UE, wherein the plurality of S-SSBs are associated with a respective plurality of beams, and wherein the beam management message indicates an optimal beam of the plurality of beams.

Example 11 comprises any variation of example 1, wherein the beam management message includes at least one S-SSB index and at least one corresponding reference signal received power (RSRP) measurement.

Example 12 comprises any variation of example 1, wherein the one or more processors further cause the UE to: detect a beam failure, wherein the beam management message is transmitted to the second UE in response to detecting the beam failure, and wherein the beam management message comprises a beam failure recovery message including a candidate S-SSB index or a candidate channel state information reference signal (CSI-RS) index, and a reference signal received power (RSRP) measurement associated with the candidate S-SSB index or the candidate CSI-RS index.

Example 13 comprises any variation of example 1, wherein the one or more processors further cause the UE to: measure a plurality of channel state information reference signals (CSI-RSs) received from the second UE, wherein the plurality of CSI-RSs are associated with a respective plurality of beams, and wherein the beam management message indicates an optimal beam of the plurality of beams.

Example 14 comprises any variation of example 1, wherein the one or more processors further cause the UE to: randomly select a sub-channel from the SL beam management resource pool for transmitting the beam management message on a physical sidelink shared channel (PSSCH) or a physical sidelink control channel (PSCCH).

Example 15 comprises any variation of example 1, wherein the one or more processors further cause the UE to: based on a UE identifier for the UE, select a sub-channel from the SL beam management resource pool for transmitting the beam management message on a physical sidelink shared channel (PSSCH) or a physical sidelink control channel (PSCCH).

Example 16 is a baseband processor for a user equipment (UE). The baseband processor comprises a memory and one or more processors coupled to the memory. The one or more processors are configured to execute instructions stored in the memory to cause the UE to: receive resource pool information indicating a sidelink (SL) beam management resource pool, and receive a beam management message from a second UE using resources in the SL beam management resource pool.

Example 17 comprises any variation of example 16, wherein the beam management message includes at least one S-SSB index and at least one corresponding reference signal received power (RSRP) measurement.

Example 18 comprises any variation of example 16, wherein the resource pool information includes resource pool configuration information indicating an association between one or more S-SSB indexes and a resource index of the SL beam management resource pool, and wherein the one or more processors further cause the UE to monitor respective resources in the SL beam management resource pool for the beam management message using respective receive (Rx) beams associated with beam indexes of the S-SSBs.

Example 19 comprises any variation of example 16, wherein the one or more processors further cause the UE to receive the beam management message using a quasi-omni receive (Rx) beam.

Example 20 comprises any variation of example 19, wherein the one or more processors further cause the UE to receive a second beam management message from a third UE using the resources in the SL beam management resource pool.

Example 21 comprises any variation of example 16, wherein the resource pool information includes resource pool configuration information indicating an offset, interval, and periodicity of the SL beam management resource pool.

Example 22 comprises any variation of example 21, wherein the periodicity of the SL beam management resource pool is the same as a periodicity of an S-SSB resource pool.

Example 23 comprises any variation of example 16, wherein the resource pool information includes resource pool configuration information indicating a time offset between an S-SSB resource pool and the SL beam management resource pool.

Example 24 is a baseband processor for a user equipment (UE). The baseband processor comprises a memory and one or more processors coupled to the memory. The one or more processors are configured to execute instructions stored in the memory to cause the UE to: receive resource pool information indicating a sidelink (SL) beam management resource pool, perform receive (Rx) beam sweeping to identify an optimal Rx beam based on a channel state information reference signal (CSI-RS) received from a second UE using resources in the SL beam management resource pool, and receive data from the second UE using the optimal Rx beam.

Example 25 comprises any variation of example 24, wherein the one or more processors further cause the UE to perform the Rx beam sweeping within a single slot, and wherein a different Rx beam is used to receive each CSI-RS symbol in the slot.

Example 26 comprises any variation of example 24, wherein the resource pool information includes resource pool configuration information indicating an offset, interval, and periodicity of the SL beam management resource pool.

Example 27 comprises any variation of example 26, wherein the resource pool information further indicates a SL synchronization signal block (S-SSB) resource pool, wherein the resource pool configuration information further indicates a periodicity of the S-SSB resource pool, and wherein the periodicity of the S-SSB resource pool is the same as the periodicity of the SL beam management resource pool.

Example 28 comprises any variation of example 24, wherein the resource pool information includes resource pool configuration information to configure a maximum number of CSI-RS ports.

Example 29 comprises any variation of example 24, wherein the resource pool information includes resource pool configuration information indicating a mapping of a plurality of CSI-RS ports to a plurality of orthogonal frequency division multiplexing (OFDM) symbols.

Example 30 comprises any variation of example 24, wherein the resource pool information includes resource pool configuration information to configure a repetition of the CSI-RS.

Example 31 is a baseband processor for a user equipment (UE). The baseband processor comprises a memory and one or more processors coupled to the memory. The one or more processors are configured to execute instructions stored in the memory to cause the UE to: receive resource pool information indicating a sidelink (SL) beam management resource pool, and transmit a plurality of channel state information reference signals (CSI-RSs) to a second UE using resources in the SL beam management resource pool.

Example 32 comprises any variation of example 31, wherein the plurality of CSI-RSs are transmitted using a single beam.

Example 33 comprises any variation of example 31, wherein the one or more processors further cause the UE to transmit a plurality of CSI-RS within a single slot.

Example 34 comprises any variation of example 33, wherein the one or more processors further cause the UE to transmit the plurality of CSI-RS from a subset of symbol 1 to symbol 12 of the slot.

Example 35 comprises any variation of example 31, wherein the one or more processors further cause the UE to transmit the CSI-RS in a same slot as a physical sidelink control channel (PSCCH) or a physical sidelink shared channel (PSSCH).

Example 36 comprises any variation of example 31, wherein the one or more processors further cause the UE to: transmit the plurality of CSI-RSs to the second UE on a respective plurality of beams, and receive a beam management message from the second UE using resources in the SL beam management resource pool.

Example 37 comprises any variation of example 36, wherein the resource pool information includes resource pool configuration information indicating configuration of CSI-RS repetition OFF.

Example 38 comprises any variation of example 36, wherein the one or more processors further cause the UE to: receive a radio resource control (RRC) message indicating resources in the beam management resource pool to be used for transmitting the plurality of CSI-RSs.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A baseband processor configured to, when executing instructions stored in a memory, perform operations comprising:
receiving resource pool information indicating a sidelink (SL) beam management resource pool; and
encoding a beam management message for transmission to a user equipment (UE) using resources in the SL beam management resource pool.

2. The baseband processor of claim 1, wherein the resource pool information includes resource pool configuration information indicating a time offset between a SL synchronization signal block (S-SSB) resource pool and the SL beam management resource pool.

3. The baseband processor of claim 1, wherein the resource pool information includes resource pool configuration information indicating an offset, interval, and periodicity of the SL beam management resource pool.

4. The baseband processor of claim 3, wherein the periodicity of the SL beam management resource pool is the same as a periodicity of an SL synchronization signal block (S-SSB) resource pool.

5. The baseband processor of claim 1, wherein resources in the SL beam management resource pool are multiplexed in a time division multiplexing (TDM) manner with resources in an S-SSB resource pool and resources in a SL data transmission resource pool.

6. The baseband processor of claim 1, wherein the resource pool information configures the SL beam management resource pool on a per slot basis.

7. The baseband processor of claim 1, wherein the resource pool information configures the SL beam management resource pool on a per sub-slot basis.

8. The baseband processor of claim 1, wherein the operations further comprise encoding the beam management message for transmission in a medium access control (MAC) control element (CE) on a physical sidelink shared channel (PSSCH).

9. The baseband processor of claim 1, wherein the operations further comprise:
measuring a plurality of SL synchronization signal blocks (S-SSBs) received from the UE, wherein the plurality of S-SSBs are associated with a respective plurality of beams;
wherein the beam management message indicates an optimal beam of the plurality of beams.

10. The baseband processor of claim 1, wherein the operations further comprise:
detecting a beam failure;
wherein the beam management message is encoded in response to detecting the beam failure;
wherein the beam management message comprises a beam failure recovery message including a candidate S-SSB index or a candidate channel state information reference signal (CSI-RS) index, and a reference signal received power (RSRP) measurement associated with the candidate S-SSB index or the candidate CSI-RS index.

11. The baseband processor of claim 1, wherein the operations further comprise:
measuring a plurality of channel state information reference signals (CSI-RSs) received from the UE, wherein the plurality of CSI-RSs are associated with a respective plurality of beams; and
wherein the beam management message indicates an optimal beam of the plurality of beams.

12. The baseband processor of claim 1, wherein the operations further comprise:
randomly selecting a sub-channel from the SL beam management resource pool for transmitting the beam management message on a physical sidelink shared channel (PSSCH) or a physical sidelink control channel (PSCCH).

13. The baseband processor of claim 1, wherein the operations further comprise:
based on a UE identifier for the UE, selecting a sub-channel from the SL beam management resource pool for transmitting the beam management message on a physical sidelink shared channel (PSSCH) or a physical sidelink control channel (PSCCH).

14. A user equipment (UE), comprising:
radio frequency (RF) circuitry; and
one or more processors coupled to the RF circuitry and configured to execute instructions stored in a memory to cause the UE to:
receive resource pool information indicating a sidelink (SL) beam management resource pool; and
receive a beam management message from a second UE using resources in the SL beam management resource pool.

15. The UE of claim 14, wherein the beam management message includes at least one S-SSB index and at least one corresponding reference signal received power (RSRP) measurement.

16. The UE of claim 14, wherein the resource pool information includes resource pool configuration information indicating an association between one or more S-SSB indexes and a resource index of the SL beam management resource pool; and
wherein the one or more processors further cause the UE to monitor respective resources in the SL beam management resource pool for the beam management message using respective receive (Rx) beams associated with beam indexes of the S-SSBs.

17. The UE of claim 14, wherein the one or more processors further cause the UE to receive the beam management message using a quasi-omni receive (Rx) beam.

18. The UE of claim 17, wherein the one or more processors further cause the UE to receive a second beam management message from a third UE using the resources in the SL beam management resource pool.

19. The UE of claim 14, wherein the resource pool information includes resource pool configuration information indicating a time offset between an S-SSB resource pool and the SL beam management resource pool.

20. A method for a user equipment (UE), comprising:
receiving resource pool information indicating a sidelink (SL) beam management resource pool; and
transmitting a beam management message to a second UE using resources in the SL beam management resource pool.
